(19) United States
(12) Patent Application Publication
(10) Pub. No.: US 2007/0129087 A1
(43) Pub. Date: Jun. 7, 2007

(54) Systems And Methods For Providing Emergency Notification

(76) Inventor: James Bell, Lebanon, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/671,313

(22) Filed: Feb. 5, 2007

Related U.S. Application Data
(63) Continuation-in-part of application No. 11/187,766, filed on Jul. 22, 2005.
(60) Provisional application No. 60/590,800, filed on Jul. 22, 2004.

(51) Int. Cl. H04Q 7/20; G08B 1/00

(52) U.S. Cl. 455/458; 340/531

(57) ABSTRACT

The present invention provides a system and a method for emergency notification that combines the incorporates the RDS/RDBS capability of selected FM radio stations, as well as a specialized addressable receiver with appropriate audio, visual and vibrating signaling capabilities. These elements are combined with a reliable and survivable communications channel to permit activation of the emergency notification signal from a software based tool provided in a command unit. This enables accurate recording of both the status of the emergency units and emergency personnel as well as permits secure notification of the emergency related information to all involved personnel in substantially real-time.

### CROSS REFERENCE TO RELATED APPLICATIONS

This application is a continuation in part of the U.S. patent application Ser. No. 11/187,766 filed Jul. 22, 2005, which claims the benefit of U.S. Provisional Application No. 60/590,800, filed Jul. 22, 2004. The entire contents of the U.S. patent application Ser. No. 11/187,766 and U.S. Provisional Application No. 60/590,800 are incorporated herein by reference.

### FIELD OF THE INVENTION

The present invention generally relates to emergency communication systems, and more particularly relates to improved emergency communications system and method for providing emergency notification with wide area capability.

### BACKGROUND OF THE INVENTION

Emergency events often cause the need to communicate with both the emergency and non-emergency personnel regarding the event and the appropriate action to take based on the event and the conditions. Some of these emergencies events include, terrorist attacks, severe weather, natural disasters, fires, war acts, toxic chemical spills, radiation leaks etc. Many lives are lost due to lack of communication during these emergency events. No example is more vivid than that of the lives lost at the World Trade Center on Sep. 11, 2001. About three thousand civilians lost their lives and three hundred forty three New York City firefighters were among 403 public safety workers who were killed when the towers collapsed.

Much of the blame for this extraordinary loss of life has been targeted on poor communications—specifically on the inability to order an evacuation utilizing the emergency department's two way radio system. Notifying firefighters or other emergency personnel of the need to evacuate a building is a critical but often poorly executed procedure during the emergency. This notification is usually made by transmissions over the emergency department's two way radio system and by sounding air horns.

The WTC disaster vividly demonstrated how ineffective the concept of the air horn method is in the urban environment. The use of two way radios in urban, suburban, and even rural venues can also be problematic, especially in the chaotic and adrenaline-charged atmosphere of a fire scene. The evacuation order has difficulty obtaining the priority it requires and competes with other radio traffic, risking being lost in the background radio “noise.”

The problems with utilizing public safety two way radio systems have been cited and analyzed in numerous reports critiquing the response and performance of public safety services at the World Trade Center. While they all cite significant problems, there is little offered in these reports to provide an effective and reliable method of notifying firefighters or other emergency personnel to evacuate a building when those in authority deem it necessary.

Providing emergency alerts and notifications to civilians both in business occupancies and in residences is also an issue. Currently no survivable method exists that is not dependant on physical connections as with conventional telephones or subject to sever channel loading as with commercial wireless services such as cellular telephony and mobile data. While information is provided by broadcast news outlets it is not necessarily the timeliest and is often edited. It is also, by its nature, broadcast to a wide area and cannot be focused to individual building which might require specific instructions.

The two way radio systems utilized by public safety forces—be they police, fire, EMS, or emergency management—are usually adequate for dispatch and status reporting. While in reality most organizations complain about coverage and reliability even in day-to-day use, these deficiencies are generally system related design issues. The equipment and systems are for the most part reliable but are plagued by systemic problems. Among these are: (a) Insufficient base station radio frequency (rf) power to ensure coverage into buildings; (b) inadequate audio power (volume) from the portable radios (walkie-talkie) to ensure that messages can be heard in a noise filled environment; and (c) insufficient battery life with portable radios to ensure communications for extended periods with a reserve for any evacuation messages. The transmissions from vehicles are at lower power and with a more inefficient antenna system than the base station, making them more difficult to be heard in a steel framed building. Thus, the traditional two-way radio system is not the ideal tool to initiate the most critical of all fire department procedures: an evacuation.

The only product identified of whose purpose is evacuation notification is manufactured by Grace Industries and marketed as the Personal Alert Safety System as disclosed in the website, www.gracesales.com/products/gemsystem/tpassevac.htm. This product utilizes spread spectrum radio technology that requires no FCC license and is shared by devices in the “Industrial, Scientific, and Medical” fields as defined by the FCC (902-928 MHz). This includes medical telemetry, cordless phones, hair removal equipment, jewelry cleaners, and the remote control of innumerable devices. Being unlicensed, there is significant risk from interference especially in urban areas and since frequency ‘loading’is totally unregulated the risk increases as new services add products. Additionally, the RF power for spread spectrum is a maximum of 1 watt but more typically ¼ watt. Grace cites a range of “one-half to one mile depending on limiting factors and environmental conditions.” The issue of low power and unlicensed frequencies makes use in urban and suburban areas questionable. Although this product is designed for evacuation notification, its low rf power output and limited-scope interface make it of little use to major fire departments or those serving larger commercial buildings. Thus, this evacuation notification by Grace Industries fails to support a comprehensive or wide area capability of public notifications.

Yet there is a radio service that does penetrate buildings of all types on a day-to-day basis. FM entertainment radio is broadcast at high power from sites with sophisticated antenna structures and received by millions of listeners everyday, many in office buildings. Driven by the need to maintain operations for revenue purposes, these stations often have back up transmitters, generators, and sometimes back up locations. What more and more stations also have is the ability to transmit “information” along with their entertainment content, utilizing the RDS (Radio Data System) format (RDS is the international definition.; in the United States, the definition is RBDS, for Radio Broadcast Data System.)

Accordingly, there is a need to provide for an improved emergency notification system, specifically to utilize existing resources such as RDS and RBDS to dramatically improve the effectiveness of emergency communication.

### SUMMARY OF THE INVENTION

In one embodiment of the present invention, there is disclosed a system having at least one radio broadcasting equipped station operable to transmit signals in at least one of RDS and RBDS format, for providing emergency related notification in substantially real-time. The system comprising at least one on-site command unit communicatively coupled to the radio broadcasting equipped station, wherein the at least one on-site command unit is configured to transmit emergency notification signal in real-time to the radio broadcasting equipped station. The radio broadcasting equipped station converts the emergency notification signal into at least one of RDS and RBDS format. The system further comprises at least one fixed receiver coupled to the radio broadcasting station. The fixed receiver is situated at the emergency location and is operable to receive the signal in the at least one of the RDS and RBDS format

In another embodiment of the present invention, there is disclosed a system having at least one radio broadcasting equipped station operable to transmit signals in at least one of RDS and RBDS format, for providing emergency related notification in substantially real-time. The system comprising at least one on-site command unit communicatively coupled to the radio broadcasting equipped station, wherein the at least one on-site command unit is configured to transmit emergency notification signal in real-time to the radio broadcasting equipped station. The radio broadcasting equipped station converts the emergency notification signal into at least one of RDS and RBDS format. The system further comprises at least one portable receiver coupled to the radio broadcasting equipped station. The portable receiver is securely attached to an emergency personnel and is operable to receive the signal in said at least one of the RDS and RBDS format.

In a preferred embodiment of the present invention, the portable receiver is further operable to receive encoded paging information such that the encoded paging information comprise RDS paging activation codes.

In another embodiment of the present invention there is disclosed a method for providing emergency related notification in substantially real-time. The method comprises receiving information related to an emergency, executing emergency notification signals in substantially real-time upon receipt of the information. The emergency notification signal comprising receiver identity and message content of the emergency. The method also comprises converting the emergency notification signal to form alert activation codes in least one of RDS and RBDS format and transmitting the alert activation codes in at least one of the RDS and RBDS format. The method further comprises receiving the alert activation codes in the at least one of RDS and RBDS format and processing the alert activation codes in the at least one of RDS and RBDS format. The method further comprises providing a notification signal to an emergency personnel based on the processed alert activation codes.

### BRIEF DESCRIPTION OF THE DRAWINGS

FIG. 1 is a schematic block diagram of an exemplary system for communicating emergency notification according to an embodiment of the present invention.

FIG. 2A is a schematic diagram of an exemplary front view of a fixed receiver of the system of FIG. 1.

FIG. 2B is a schematic diagram of an exemplary rear view of a fixed receiver of the system of FIG. 1.

FIG. 2C is a schematic diagram of exemplary portable receiver of the system of FIG. 1.

FIG. 3 is a schematic diagram of the application of the receiver in accordance with an embodiment of the present invention.

FIG. 4 is an exemplary flow diagram for communicating emergency notification according to the embodiment of the present invention.

### DETAILED DESCRIPTION OF PREFERRED EMBODIMENTS

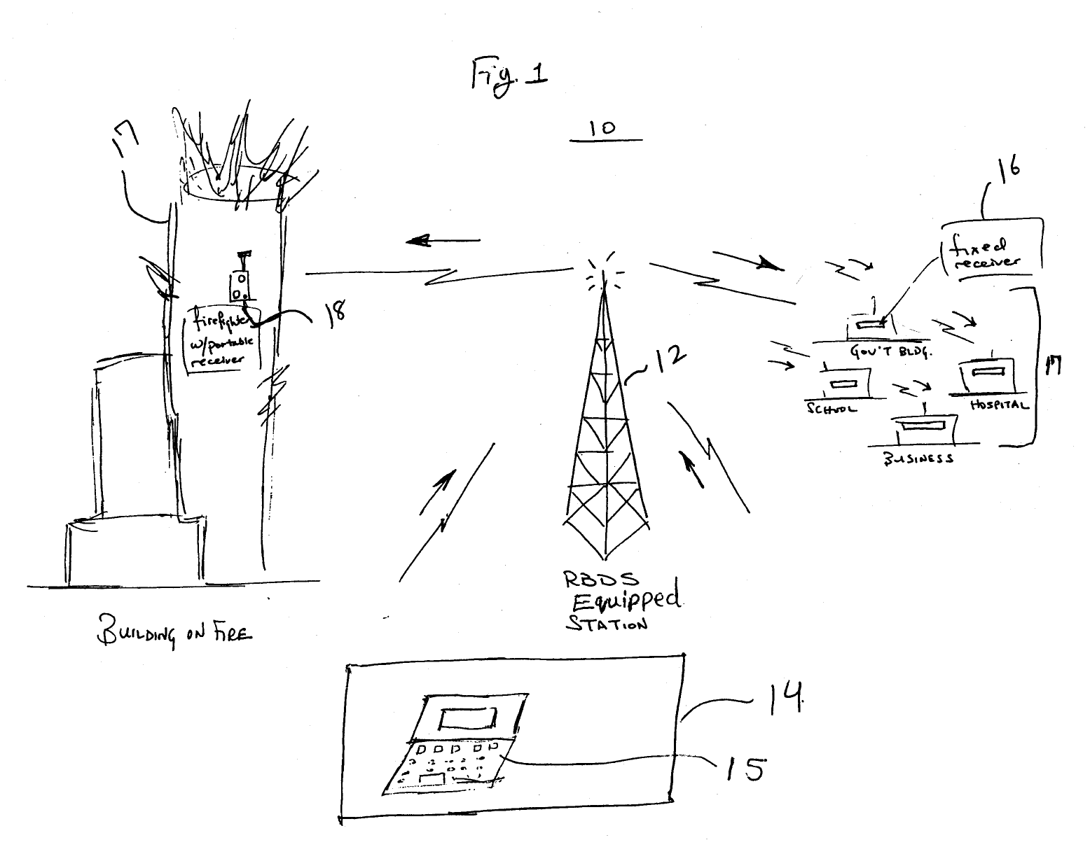

Referring now to the drawings, FIG. 1 illustrates an exemplary network architectural system 10 for communicating emergency notification according to one embodiment of the present invention. The system 10 preferably utilizes conventional FM radio broadcasts powered adequately to service areas as licensed by the Federal Communications Commission (FCC). The frequency range for FM broadcast systems is 88-108 Mhz. The system 10 comprises a Radio Broadcasting Equipped Station 12 operable to transmit signals in both the RDS and the RBDS format as will be discussed in detail below. The system 10 further comprises an on-site command unit 14 coupled to the radio broadcasting equipped station 12 preferably via at least one back-channel data communication link. The command unit is preferably located on an emergency personnel transportation unit such as a fire chief car or police car etc; in an emergency management stations such as fire headquarters, police stations etc. or any other emergency management units. Upon notification of an emergency, the command unit 14 transmits emergency notification signal in substantially real-time to the radio broadcasting equipped station 12.

The emergency notification signal preferably comprises of several components. The first component comprises identity of a receiver, i.e. a fixed receiver 16 and/or a portable receiver 18 as described in greater detail below. The second component comprise the message content related to the emergency. The message content may preferably comprises the type of emergency and instructions to follow in the emergency. Such instructions may preferably comprise evacuate the building, remain on your floor, etc. In other words, some type of action item that guides the firefighter or any other emergency personnel as to what he/she should do. Note that the message content may preferably comprise any other pertinent information related to the emergency. As discussed above, such pertinent information may preferably comprise status information of emergency personnel, status of emergency mobile units etc. Furthermore, the message content may preferably comprise a code i.e. alert activation codes that triggers embedded text message or preferably comprise the text message itself.

The command unit 14 is preferably equipped with a computer operable software based tool 15 that which enables commanders, dispatchers or other emergency personnel to accurately record the status information of emergency departments such as fire companies at the location of an emergency. Status information may preferably comprise arrival/departure of the emergency transportation units, for ex. fire engines, arrival/departure of the emergency personnel such as firefighters, health related conditions of the emergency personnel etc. Furthermore, the command unit 14 is configured to permit emergency notification signal to all involved personnel in an emergency situation. There will be wireless connectivity between the command unit 14 and the radio broadcasting equipped station 12 in order notify regarding the emergency. The transmission of the emergency notification signal from the command unit 14 to the radio broadcasting equipped station 12 will be some standard format known in the art.

The communications channel for signal activation and the software based tool 15 can be developed and implemented utilizing commercially available products and services. The system can preferably utilize redundant communications back channel data links to convey the evacuation or emergency notification between the incident commander or emergency manager and the RBDS provisioned radio stations. The methods utilized will include, proprietary two way radio, SMS messaging, internet connectivity, cellular data networks (including G3 and EVDO), Wi Fi, WiMax, microwave, and satellite. While all these technologies can be utilized to transport the protocol for system activation, the methods actually utilized will be those necessary to achieve redundant secure communications on a customer by customer basis.

Upon receipt of the emergency notification signal from command unit 14, the radio broadcasting equipped station 12 translates/converts the signal in the RDS and/or RBDS format and preferably transmit it wirelessly. Thus the second wireless component is broadcast from the radio broadcasting equipped station 12 transmission. Both RDS and RBDS are well known protocol communication of radio broadcasting equipped station 12. This communication provides for sending small amounts of digital information using the conventional FM radio broadcasts. RBDS and RDS is an established, standards-based technology that permits FM radio stations to transmit data comprising text based information in conjunction with the entertainment portion of the broadcast. Compatible receivers with display capabilities can provide text station identification, artist identity, and road and traffic conditions. An additional component of the RDS technical standard is “paging” which permits operation in a manner similar to the “beeper” paging, a communication device so popular in the pre-cell phone era. This component is powerful enough to penetrate buildings.

Furthermore, the system 10 of FIG. 1 preferably comprises a fixed receiver 16 and a portable/personal receiver 18 that is coupled wirelessly to the radio broadcasting equipped station 12 to receive the alert activation codes in RDS or RBDS format. Both the fixed receiver 16 and the portable receiver 18 are preferably public safety receivers that are coupled to the radio broadcasting equipped station 12 to receive the emergency notification signal in RDS or RBDS format.

As shown in FIG. 1, the fixed receiver 16 may preferably be located at a building 17 such as gov't building, school, hospital, other businesses etc. The portable/personal receiver 18 is desirably attached to the emergency personnel such as a firefighter or first responder in the rescue team. The command unit 14 is what permits the commander to select which unit are to receive the signal and what will the message content of the signal going to be such as instructions to evacuate, stay on your floor, i.e. some sort of action item. For example. a school system may include five schools, however, only the Washington school is on fire, so only need to evacuate the Washington school, thus, the objective is to transmit the signal to the fixed receiver 16 in Washington School. Preferably, the PC tool 15 of the command unit 14 is what the fire chief or another emergency personnel would use to transmit emergency notification signal to the radio broadcasting equipped station 12. The radio broadcasting equipped station 12 will then interpret that signal and transmit the appropriate emergency signal in RDS or RBDS format with high power capability to the fixed receiver 16 and the portable receiver 18.

The fixed and portable receivers 16 and 18 of the present invention can not only perform the functions of the firefighter/first responder portable evacuation receiver of this invention, but also sustain the environment, and respond to the RDS signaling. The design for both the receivers will be similar except that the packaging and power components will be appropriate to each receivers function as described in greater detail below.

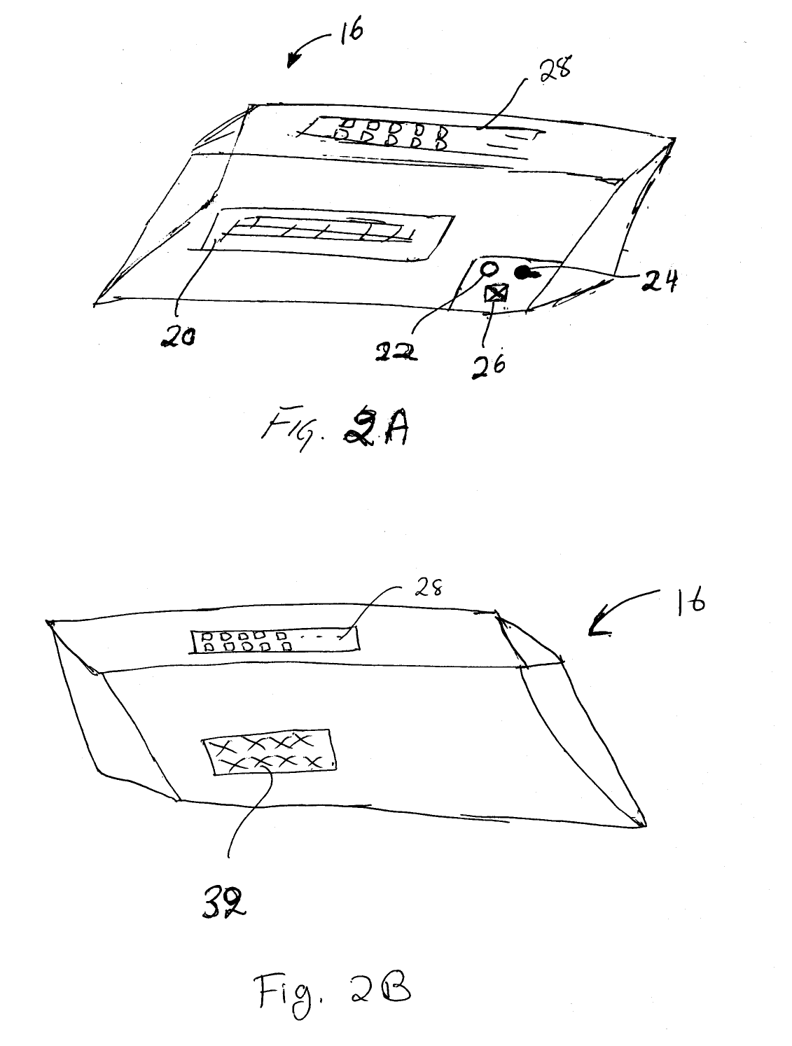

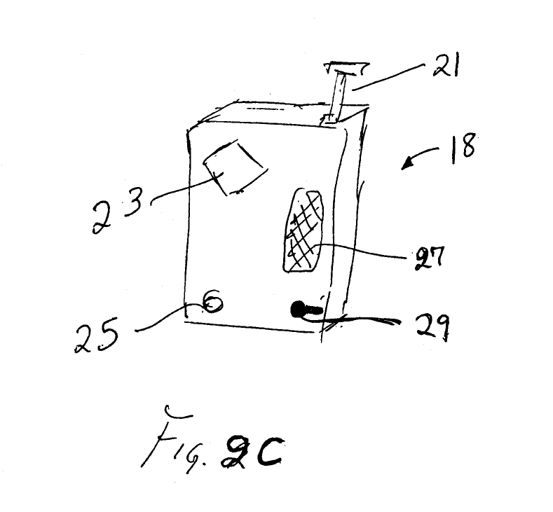

Referring to FIGS. 2A and 2B, there is shown an exemplary front view of the receiver 16 and back view of the receiver 16, respectively, according to a preferred embodiment of the present invention. The entire fixed receiver 16 (including back up battery) preferably is housed in a desk top enclosure measuring approximately 8.8″×2.8″×7.8 preferable with an Vacuum Fluorescent Display (VFD) text display 20 on the front panel. The fixed receiver 16 preferably is powered by 110 volts AC and preferably has an internal rechargeable battery. This low power RDS/RBDS receiver preferably utilizes phase locked loop tuning, permitting scanning for appropriate FM stations. Sensitivity preferably is increased by preferably utilizing an external flexible antenna (not shown).

Although, not shown, a power monitor and management circuit preferably is incorporated into the receiver 16. By utilizing a power monitor circuit, a low output red LED display 22 preferably mounted flush with the case will be illuminated at all times when the battery meets the minimum power threshold for satisfactory performance. Minimum battery life in stand by monitoring mode with two alert cycles of 10 minutes each preferably is 96 hours. Also provided in the receiver are power on/off switch 24 and an alert signal 26. Note that the alert signal 26 functions as a visual signal upon receipt of the emergency notification signal. Additionally, an alert audio transducer 32 is mounted on the back panel of the receiver 16 as shown in the back view of the receiver in FIG. 2B. The alert audio transducer 32 functions as an audible signal upon receipt of the emergency notification signal. Since the receiver 16 has FM radio capability, it can also function to receive off the air radio audio via a plurality of buttons 28 for tuning as shown in FIG. 2A. It is important to note this function does not interrupt the RBDS format of emergency notification.

The portable receiver 18 (including battery) as shown in FIG. 2B is preferably housed in a watertight, fire-proof environment, desirably in a plastic case. The only penetrations of the case preferably are for an antenna 21, an alert indicator/signal 23, a battery condition indicator 25 and a power on/off switch 29. Both power on/off switch 29 and resetting the alert signal 23 preferably are accomplished by a coded proximity key that are preferably maintained by a supervisor or a higher authority management. The alert indicator 23 functions as an visual signal upon receipt of the emergency notification signal. The alert indicator 23 of the portable receiver 18 can also preferably function in vibration mode. As shown in FIG. 2B, the portable receiver 18 also comprises an alert audio transducer 27 which functions as an audible signal upon receipt of the emergency notification signal.

The preferred approximate size of the portable receiver is 2.25″×4.0″×1.5.″ The case preferably has an integral locking clip (not shown) that can rotate to assure proper positioning. The portable receiver 18 is preferably powered by rechargeable nickel hydride batteries. The charging circuit preferably utilizes low voltage inductive coupling of 12 volts AC with a 110 volt charger. This reduces power contacts and corrosion problems.

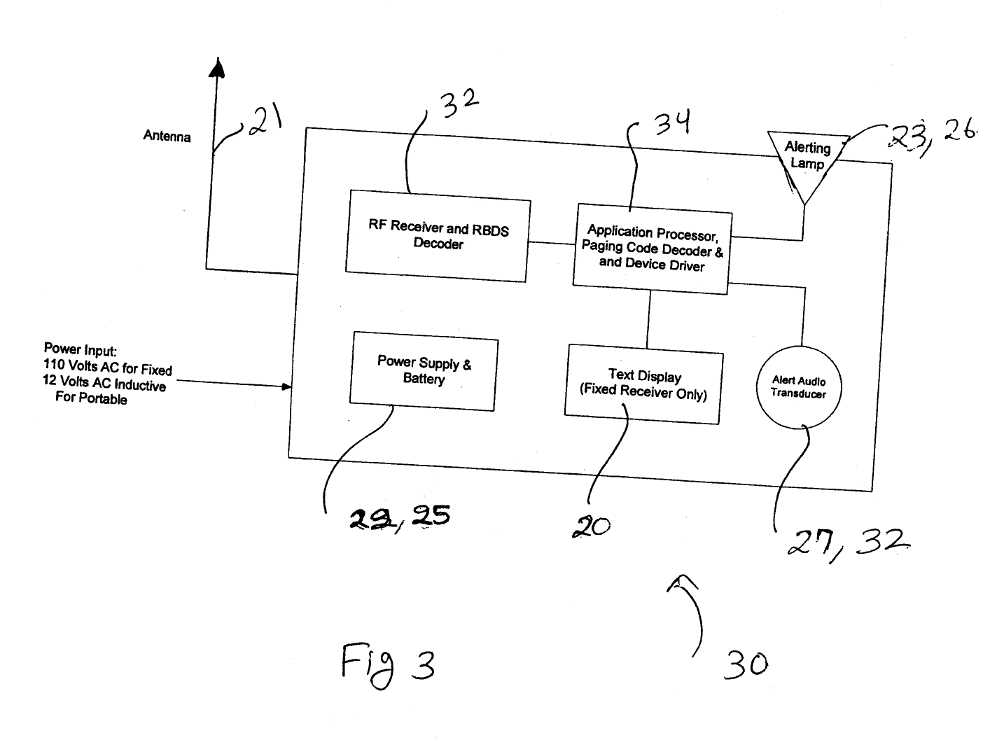

Referring to FIG. 3, there is shown an exemplary block diagram of the application 30 of the both the fixed receiver 16 and the portable receiver 18. The receivers 16 and 18 may preferably comprise a self contained Radio Broadcast Data System (RBDS) receiver 32 with addressable paging capabilities and alerting functionality. The RBDS receiver operates in conjunction with RBDS broadcasts from selected FM stations equipped with paging encoder capabilities. The alert activation preferably is initiated by a code transmitted by an on-site command 14 via a back-channel data link. Paging the message, i.e. message that was transmitted would have the address of a receiver/pager to address individual radios. Paging is a protocol of the RBDS specification.

RDS paging activation codes preferably are read and decoded by a preferably by a chip 34 which functions as an application processor, paging code decoder & device driver. The paging code decoder permits identity of the unique receiver. The application processor defines the function of this receiver. The device driver is an interface between the application processor and the alerting lamp and further operates the audio transducer 27 of the portable receiver 18, the alert indicator 23 of the portable receiver and the alert indicator 26 of the fixed receiver 16, the audio transducer of the fixed receiver 16, and text display 20 of the fixed receiver 16. This enables driver circuits which activate a solid state audio transducer capable of producing a sound level of 95 dBA. The driver may produce a cycling of the transducer output so that the audio signal is more noticeable. The decoder chip preferably also activates a driver that powers a white high-output flashing LED indicator mounted in a clear Fresnel lens on the top of the portable receiver 18. The circuit will cause the LED to flash for visual notification.

Programming the receiver paging code preferably is done by an inductively coupled tool utilizing a Windows-based PC as the input device. The receiver can be coded to any one of the unique codes defined by the United States RBDS Standard, Apr. 9, 1998 (approximately 40,000 codes per broadcast network are available). Also, note that the power input is preferably 110 volts AC for the fixed receiver 16 and 12 volts AC inductive for the portable receiver 18.

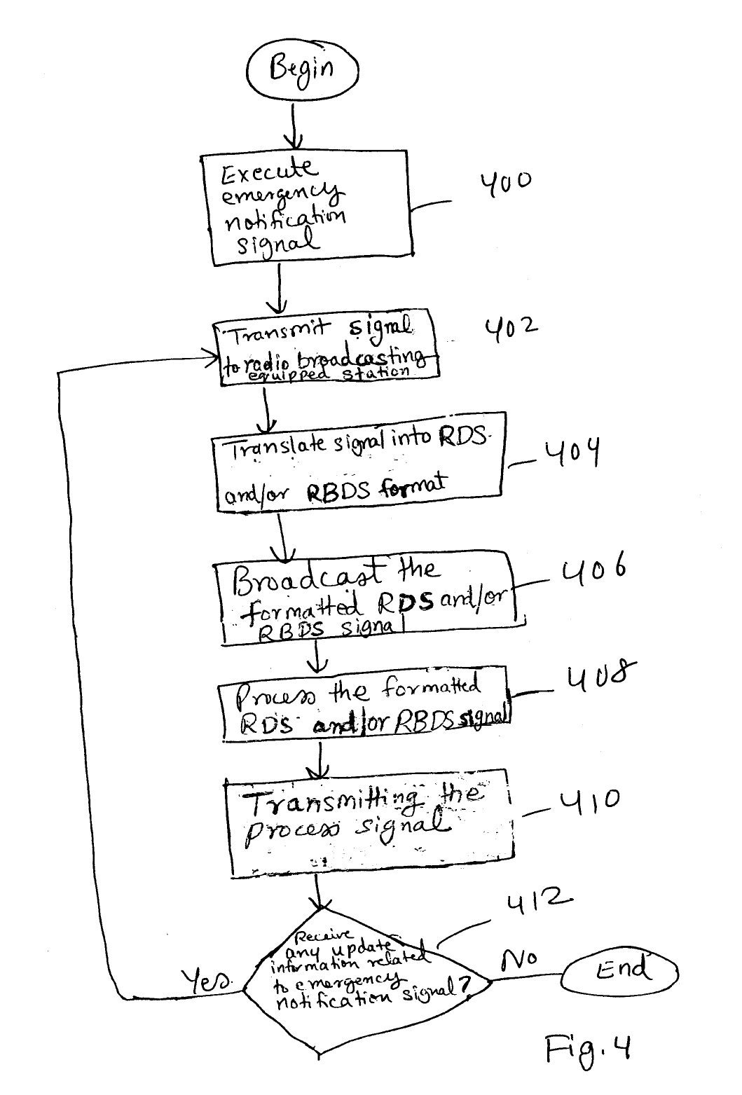

Referring to FIG. 4, there is disclosed an exemplary flow diagram for communicating emergency notification according to the embodiment of the present invention. Upon a case of an emergency, for example, a building such as a school, is on fire, an emergency station is notified. Upon receipt of the information on the emergency, in step 400, an emergency notification signal is executed in real-time. This signal is activated/executed by utilizing the PC (software on the PC) of the command unit 14. As discussed above, the emergency notification signal preferably comprises of several components. The first component comprises identity of the receiver. The second component comprise the message content related to the emergency. The message content may preferably comprise the type of emergency and instructions to follow in the emergency and/or any other pertinent information related to the emergency. In other words, some type of action item that guides the firefighter or any other emergency personnel as to what he/she should do.

The emergency notification signal is then transmitted to the radio broadcasting equipped station 12 by the command unit 14 at step 402. This signal is preferably sent wirelessly to the radio broadcasting equipped station 12 any standard format known in the art. Upon receipt of the emergency notification signal, the radio broadcasting equipped station 12 translates the signal into RDS and/or RBDS format at step 404. Then at step 406, the radio broadcasting equipped station 12 broadcasts the RDS and/or RBDS formatted signal to the receivers, i.e. the fixed receiver 16 and/or the portable receiver 18. Upon receipt of the RDS and/or RBDS formatted signal, at step 408, the receivers 16 and 18 process the signal in a format understood by the emergency personnel. As discussed above, the processing comprises decoding RDS and/or RBDS formatted signal into decoded message understood by the emergency personnel. Then, at step 410, the decoded message are then provided/communicated to the emergency personnel. The decoded message may preferably be provided as a notification signal as visually displayed in text and/or including light such as LED display and/or including audible notification.

It is important to note that even upon providing the emergency personnel of the emergency notification, the emergency situations may change during the course of time which may require the execution of the updated emergency notification signal to change or update the content information of the initial emergency notification signal. Such updates may preferably comprise change in the message content of the signal. For example, the initial emergency notification signal may contain message content such as remain on your floor, however the updated signal may contain message content such as evacuate the building immediately or may contain information such as there are four additional firefighters in the school building with the exact location of these firefighters. Thus, at step 412, it is now at the determined at the command unit 14, if there is any updated information related to the emergency notification signal. If not, then the communication has ended. If yes, the updated emergency notification signal is executed at step 414 and steps 402 to 412 are repeated.

While the preferred embodiment of the invention described above provides a system and method for providing reliable safety notification for firefighters and other first responders in more urban environments, it is to be noted that the invention can be employed in other applications as well. Utilizing the addressability of the portable receivers, the system as described above can preferably be utilized for wide area public warning in areas subject to tornados and flooding or for evacuation warnings near nuclear power plants. The forest fire services could benefit from a wide area alerting and notification capability and this concept could support that need. The system could be utilized for emergency and critical need personnel mobilization.

Furthermore, utilizing the addressability of the fixed location receivers, the system as described above can preferably provide specific warning and notifications messages to building tenants for appropriate action to any type of emergency. This can be extended to providing floor-by-floor notifications in high rise buildings. Beyond urban first responders, the system can preferably support volunteers in more suburban and rural areas. These capabilities as described above will permit emergency mangers to provide timely and appropriate instructions to first responders, residents, business occupants etc. for emergency situation.

In addition to the domestic market, the public safety notification and other emergency functions could be marketed globally. As well known, RDS currently has significant deployment in Europe.

Support for the scaling capabilities of the system of the present invention and the relative ease of customer expansion lies in the fact that radio stations typically cover an extended geographic area. By way of example, a New York station can easily serve an area of at least twenty miles in diameter, allowing coverage of municipalities in Long Island, N.J., and Westchester County, N.Y. This expanded market can be served with little or no cost infrastructure cost increase.

While the New York example of system suitability is most dramatic, this system can be replicated nationally in all markets utilizing the same concept and techniques. The development costs are basically a one time expense and the greater the deployment the greater the revenue and profit.

Although various embodiments that incorporate the teachings of the present invention have been shown and described in detail herein, those skilled in the art can readily devise many other varied embodiments that still incorporate these teachings without departing from the spirit and the scope of the invention.

1. A system having at least one radio broadcasting equipped station operable to transmit signals in at least one of RDS and RBDS format, for providing emergency related notification in substantially real-time, comprising:
at least one on-site command unit communicatively coupled to said radio broadcasting equipped station, wherein said at least one on-site command unit is configured to transmit emergency notification signal in real-time to the radio broadcasting equipped station;
said radio broadcasting equipped station converts the emergency notification signal into at least one of RDS and RBDS format; and
at least one fixed receiver coupled to said radio broadcasting station; said fixed receiver operable to receive the signal in said at least one of the RDS and RBDS format, said fixed receiver situated at the emergency location.

2. The system of claim 1 further comprising:
at least one portable receiver coupled to said radio broadcasting equipped station, said portable receiver operable to receive the signal in said at least one of said RDS and RBDS format, said portable receiver securely attached to an emergency personnel.

3. The system of claim 2 wherein said portable receiver is further operable to receive encoded paging information.

4. The system of claim 3, wherein said encoded paging information comprises the at least one of the RDS and RBDS paging activation codes.

5. The system of claim 2 wherein said portable receiver and said fixed receiver comprises an application processor for processing the at least one of said RDS and RBDS format alert activation codes.

6. The system of claim 2 wherein said processor comprise a decoder for decoding the at least one of said RDS and RBDS alert activation codes.

7. The system of claim 2 wherein said portable receiver and said fixed receiver comprise an alerting device for providing notification of the processed alert activation codes.

8. The system of claim 7 wherein said alerting device comprises a display unit, an audio unit, a vibration unit or combinations thereof.

9. The system of claim 1, wherein said on-site command unit is a computer operable to record status of emergency mobile units and emergency personnel

10. The system of claim 1, wherein said command unit is communicatively coupled to said radio broadcasting station via at least one back-channel data communication link.

11. The system of claim 10 wherein said back-channel data communication link is a wireless data communication link.

12. The system of claim 10, wherein said back-channel data communication link is a wired data communication link.

13. The system of claim 1 wherein said emergency notification signal comprise type of emergency, location information of the emergency and message content related to the emergency.

14. A system having at least one radio broadcasting equipped station operable to transmit signals in at least one of RDS and RBDS format, for providing emergency related notification in substantially real-time, comprising:
at least one on-site command unit communicatively coupled to said radio broadcasting equipped station, wherein said at least one on-site command unit is configured to transmit emergency notification signal in real-time to the radio broadcasting equipped station;
said radio broadcasting equipped station converts the emergency notification signal into at least one of RDS and RBDS format; and
at least one portable receiver coupled to said radio broadcasting equipped station, said portable receiver operable to receive the signal in said at least one of said RDS and RBDS format, said portable receiver securely attached to an emergency personnel.

15. The system of claim 14 further comprising:
at least one fixed receiver coupled to said radio broadcasting station; said fixed receiver operable to receive the signal in said at least one of the RDS and RBDS format, said fixed receiver situated at the emergency location.

16. The system of claim 14 wherein said portable receiver is further operable to receive encoded paging information.

17. The system of claim 16, wherein said encoded paging information comprises the at least one of the RDS and RBDS paging activation codes.

18. The system of claim 14 wherein said portable receiver and said fixed receiver comprises an application processor for processing the at least one of said RDS and RBDS format alert activation codes.

19. The system of claim 18 wherein said processor comprise a decoder for decoding the at least one of said RDS and RBDS alert activation codes.

20. The system of claim 14 wherein said portable receiver and said fixed receiver comprise an alerting device for providing notification of the processed alert activation codes.

21. The system of claim 20 wherein said alerting device comprises a display unit, an audio unit, a vibration unit or combinations thereof.

22. The system of claim 14, wherein said on-site command unit is a computer operable to record status of emergency mobile units and emergency personnel

23. The system of claim 14, wherein said command unit is communicatively coupled to said radio broadcasting station via at least one back-channel data communication link.

24. The system of claim 14 wherein said back-channel data communication link is a wireless data communication link.

25. The system of claim 14, wherein said back-channel data communication link is a wired data communication link.

26. The system of claim 14 wherein said emergency notification signal comprise type of emergency, location information of the emergency and message content related to the emergency.

27. A method for providing emergency related notification in substantially real-time, the method comprising:
(a) receiving information related to an emergency at a command unit;
(b) executing emergency notification signals upon receipt of said information; said emergency notification signal comprising receiver identification and message content of the emergency;
(c) forwarding said emergency notification signal to a radio broadcasting equipped station for conversion of said signal into at least one of RDS and RBDS format;
(d) receiving said at least one of RDS and RBDS format signal;
(e) processing said at least one of RDS and RBDS format signal; and
(f) transmitting said processed signal to an emergency personnel.

28. The method of claim 27 wherein said processing comprises decoding said RDS and RBDS format signal.

29. The method of claim 27 further comprising receiving encoded paging information.

30. The method of claim 27 wherein said encoded paging information comprises the at least one of the RDS and RBDS paging activation codes.

31. The method of claim 27 further comprising receiving an updated information related to the emergency.

32. The method of claim 31 further comprising repeating steps (b) through (f) upon receipt of said updated information.

33. The method of claim 27 wherein said message content comprise type of emergency, an action related to the emergency, status of emergency personnel, status of emergency mobile units or combinations thereof.

34. The method of claim 27 wherein said notification signal is an audio signal.

35. The method of claim 27 wherein said notification signal is a visual signal.

36. The method of claim 27 wherein said notification signal is a vibration signal.
